(19) United States
(12) Patent Application Publication
(10) Pub. No.: US 2004/0062530 A1
(43) Pub. Date: Apr. 1, 2004

(54) Optical disk for recording HD and SD contents and optical disk device

(76) Inventors: Yasufumi Tsumagari, Yokohama-shi (JP); Kazuhiko Taira, Yokohama-shi (JP); Hideki Mimura, Yokohama-shi (JP)

Correspondence Address: PILLSBURY WINTHROP, LLP, P.O. BOX 10500, MCLEAN, VA, 22102, US

(21) Appl. No.: 10/638,478

(22) Filed: Aug. 12, 2003

(30) Foreign Application Priority Data
Aug. 13, 2002 (JP) 2002-235833

(51) Int. Cl. H04N 5/781

(52) U.S. Cl. 386/125; 386/126

(57) ABSTRACT

An optical disk such as a DVD having recorded therein control information as well as the video objects of two types of contents including first contents and second contents is disclosed. This control information achieves proper reproduction for both an optical disk device intended only for the second contents and an optical disk device intended for the first contents.

### CROSS-REFERENCE TO RELATED APPLICATIONS

This application is based upon, and claims the benefit of priority from the prior Japanese Patent Application No. 2002-235833, filed Aug. 13, 2002, the entire contents of which are incorporated herein by reference.

### BACKGROUND OF THE PRESENT INVENTION

1. Field of the Invention

The present invention relates to an optical disk such as a DVD (digital versatile disk) and an optical disk device for reproducing information from the optical disk, or in particular to an optical disk and an optical disk device for recording two types of video objects including HD (high definition) contents and SD (standard definition) contents.

2. Description of the Related Art

In recent years, “DVD Specifications for Read-Only Disc Part 3: VIDEO SPECIFICATIONS” has been published in August, 1996 as a standard for reproducing the video/audio information recorded in an information recording medium from a DVD forum. This standard covers presentation data with the actual video/audio data recorded and navigation data for managing the presentation data. The presentation data are configured of video data, audio data and sub-picture data multiplexed, which are according to the specification of the program stream (2048 bytes) defined in MEG2. The navigation data, on the other hand, includes the description of the PAC and the cells for setting the time configuration and the sequence of the video/audio data to be reproduced, and realizes such functions as multi-angle, multi-story and parental.

In the prior art described above, however, the SD (standard definition) video contents (hereinafter referred to as SD contents) can be recorded in a disk, but not the HD (high definition) video contents (hereinafter referred to as HD contents), where HD is defined as a standard for the next-generation video information which achieves a high image quality equivalent to the Hi-Vision digital TV or the like. As compared with the number of pixels which is 720×480 or 720×576 for the conventional SD, the HD contents include pixels in the number of 1920×1080 or 1920×1152.

In association with this, Jan. Pat. Apple. KOKAI Publication No. 2002-170361 discloses an optical disk device for handling an optical disk to record HD and SD contents. However, the technique for reproducing, accurately without confusion, the HD and SD contents governed by different standards, is not disclosed at all.

Therefore, the problem is that even in the case where a DVD disk for recording the HD video contents or a player for reproducing the HD contents from the DVD is newly fabricated, a malfunction may be caused or if not a malfunction, the operation may be finished without reproduction in view of the fact that the existing DVD players are not intended for a DVD disk to record the HD video contents.

Specifically, in the conventional DVD and the optical disk device handling the same, the problem is posed that the HD contents and the SD contents recorded in the DVD cannot be both reproduced accurately without confusion by the conventional optical disk device or an optical disk device intended for the HD contents.

### BRIEF SUMMARY OF THE INVENTION

According to one aspect of the present invention, there is provided an optical disk to record two types of video objects including first contents and second contents and further record predetermined control information.

According to another aspect of the present invention, there is provided an optical disk device having an optical disk rotated at a predetermined speed to record two types of video objects including first contents and second contents and further predetermined control information, the optical disk device comprising a detection unit to detect the first contents, the second contents and the control information, a setting unit to set the set information to reproduce selected one of the first contents and the second contents, and a reproducing unit to reproduce at least one of the first contents and the second contents based on the control information detected by the detection unit and the set information set by the setting unit.

### BRIEF DESCRIPTION OF THE DRAWINGS

FIG. 1 is a diagram showing an example of a first data structure for a HD-DVD video disk making up an optical disk according to one embodiment of the present invention;

FIG. 2 is a diagram showing an example of a data structure for a DVD video disk having no features of the present invention;

FIG. 3 is a diagram showing an example of a file structure for a HD-DVD video disk making up an optical disk according to one embodiment of the present invention;

FIG. 4 is a diagram showing an example of a second data structure for a HD-DVD video disk making up an optical disk according to one embodiment of the present invention;

FIG. 5 is a diagram showing an example of a second file structure for a HD-DVD video disk making up an optical disk according to one embodiment of the present invention;

FIG. 6 is a diagram showing an example of a video object of a HD-DVD video disk making up an optical disk according to one embodiment of the present invention;

FIG. 7 is a block diagram showing an example of a configuration of an optical disk device handling a HD-DVD video disk making up an optical disk according to one embodiment of the present invention;

FIG. 8 is a diagram showing an example of a configuration of the P_CFG structure for a HD-DVD video disk making up an optical disk according to one embodiment of the present invention;

FIG. 9 is a diagram showing an example of a set value of an optical disk device handling a HD-DVD video disk making up an optical disk according to one embodiment of the present invention;

FIG. 10 is a flowchart showing an example of the process for reproducing the SD/HD contents of an optical disk device according to one embodiment of the present invention;

FIG. 11 is a flowchart showing an example of the process for reproducing a menu of the SD/HD contents of an optical disk device according to one embodiment of the present invention;

FIG. 12 is a flowchart showing an example of an outline of the reproduction process of an optical disk device according to one embodiment of the present invention;

FIG. 13 is a flowchart showing an example of the reproduction process of an optical disk device according to one embodiment of the present invention; and

FIG. 14 is a diagram for explaining a case in which an optical disk device having no features of the present invention jumps HD in response to a jump command of the HD-DVD video disk making up an optical disk according to one embodiment of the present invention.

### DETAILED DESCRIPTION OF THE INVENTION

An optical disk such as a DVD video disk and an optical disk device using the DVD video disk according to an embodiment of the present invention will be explained below referring to the accompanying drawings.

(Optical Disk such as DVD According to the Present Invention)

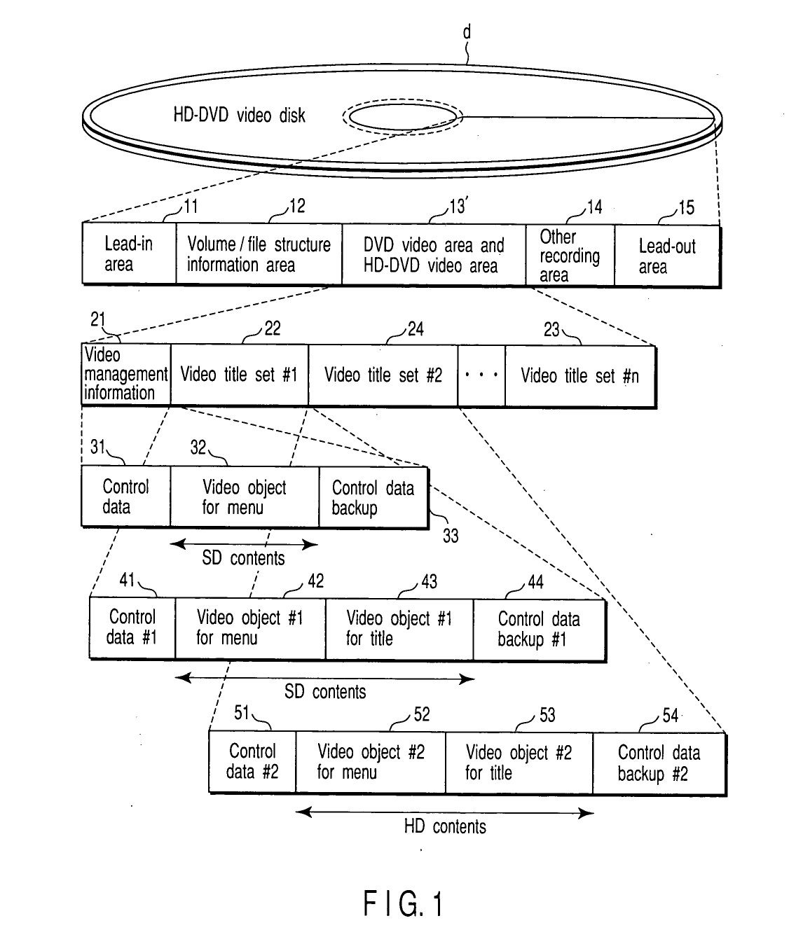

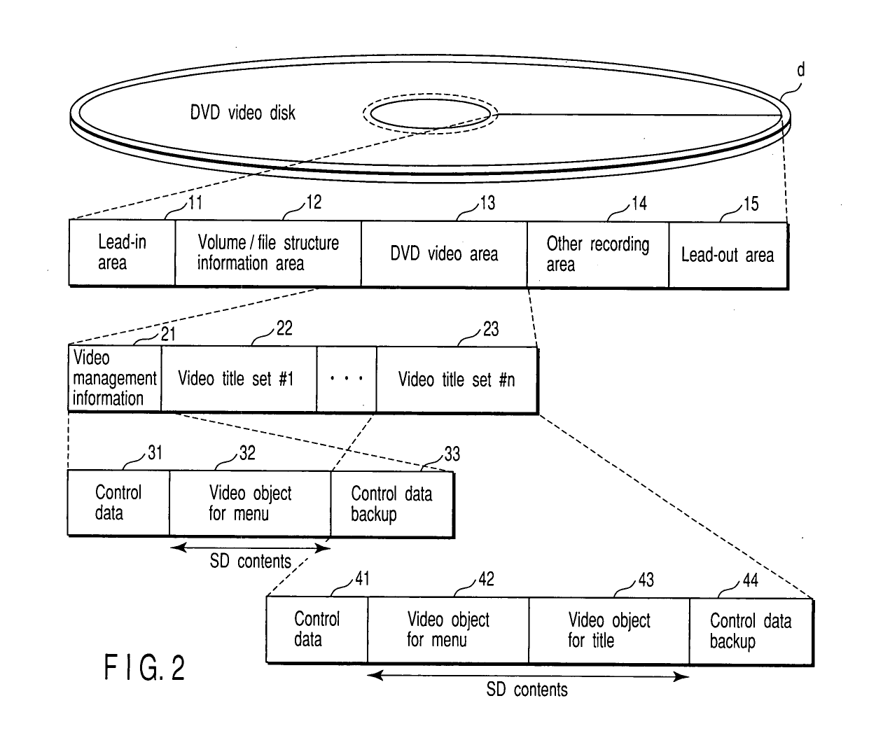

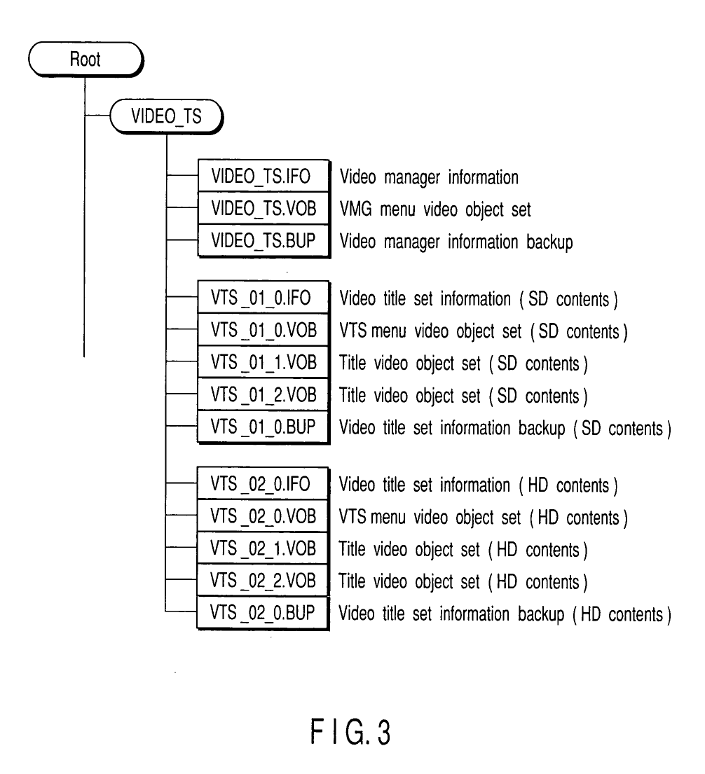

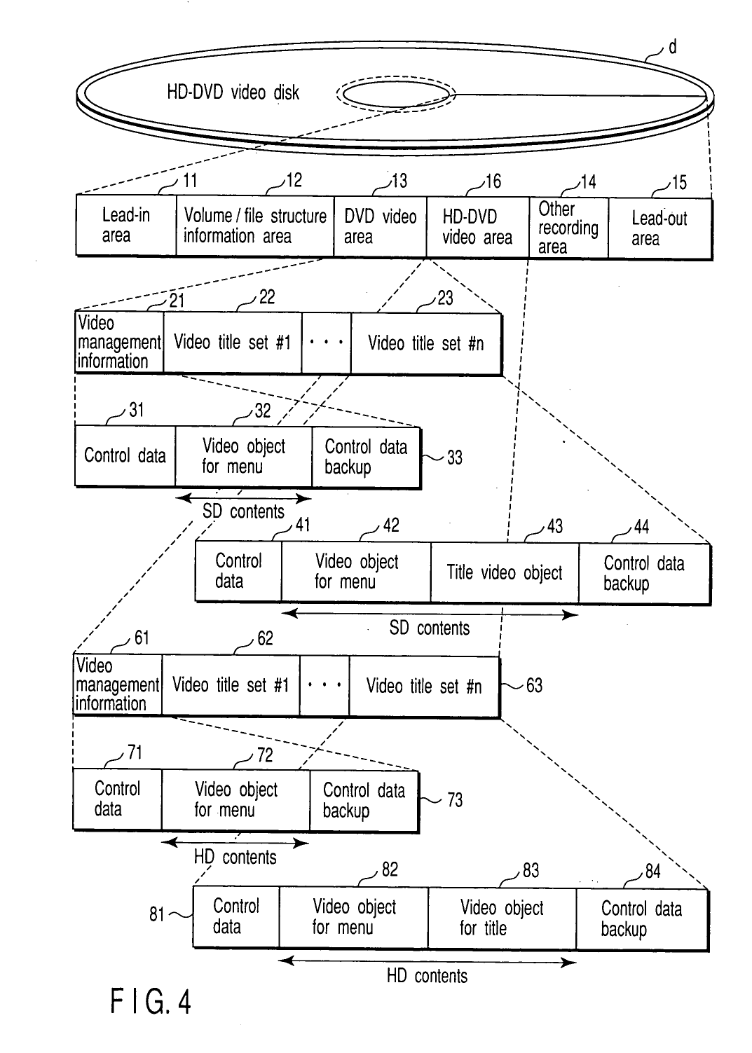

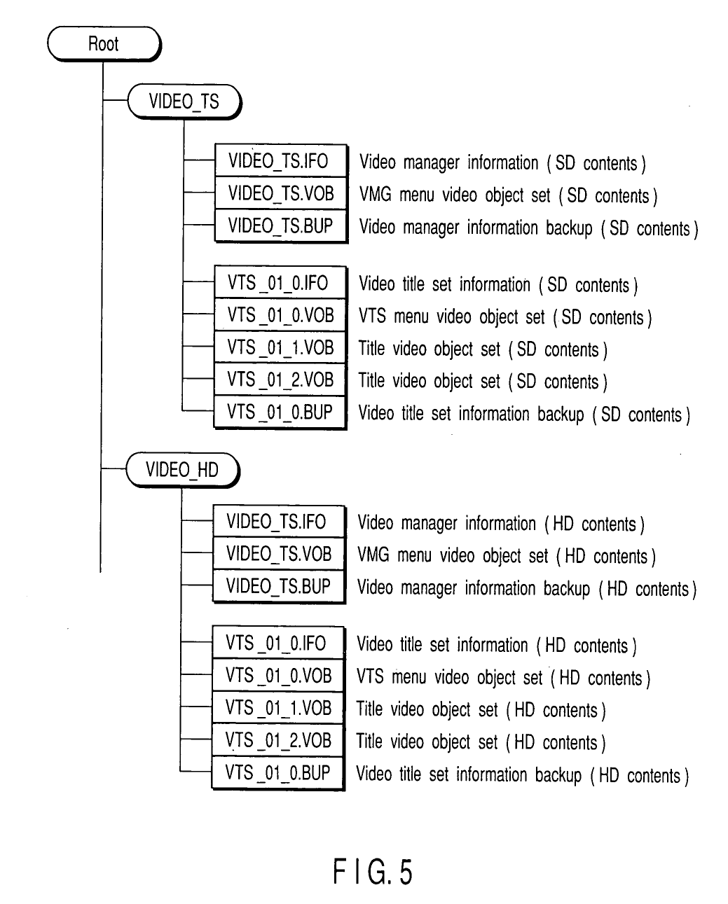

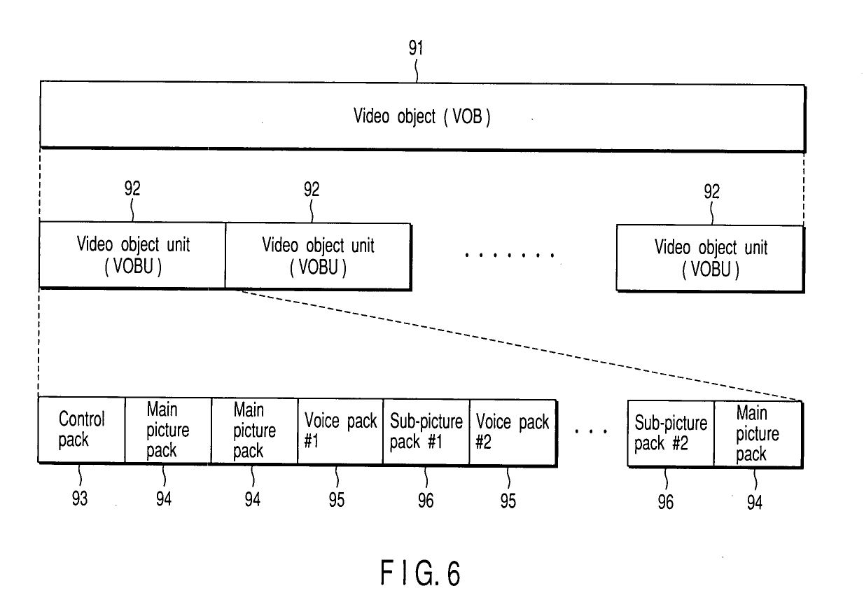

The optical disk such as the DVD according to the present invention has recorded therein at least two types of video objects including HD (high definition) contents and SD (standard definition) contents. In order to assure the reproduction processing on any optical disk device, the optical disk has further recorded therein the control information such as the command information for identifying the type of the optical disk device. FIG. 1 is a diagram showing an example of a first data structure of a HD-DVD video disk making up an optical disk according to the present invention, FIG. 2 a diagram showing an example of a data structure of a DVD video disk having no features of the present invention, FIG. 3 a diagram showing an example of a file structure of a HD-DVD video disk making up an optical disk according to the present invention, FIG. 4 a diagram showing an example of a second data structure of a HD-DVD video disk, FIG. 5 a diagram showing an example of a second file structure of a HD-DVD video disk, and FIG. 6 a diagram showing an example of a video object of a HD-DVD video disk.

The recording area of the DVD video disk according to the present invention, as shown in FIG. 1, includes a lead-in area 11, a volume space and a lead-out area 15 in the order from the inner periphery. The volume space includes a volume/file structure information area 12 and a DVD video area (DVD video zone) 13′, and further can optionally include another recording area (DVD other zone) 14. The DVD video area (DVD video zone) 13′ of the DVD video disk according to the present invention has recorded therein the SD contents and the HD contents.

The SD contents and the HD contents can be recorded by being switched by VTS (video title set). In this embodiment, as shown in FIG. 1, the SD contents are recorded in VTS #1 and the HD contents in VTS #2. This is only illustrative, and the configuration of the SD contents and the HD contents can be freely determined by title.

The volume/file structure information area 12 is assigned for the UDF (universal disk format) bridge structure. The volume of the UDF bridge format is recognized in accordance with Part 2 of ISO/IEC13346. The space for recognizing this volume includes two successive sectors starting from the first logic sector of the volume space shown in FIGS. 1 and 2. This first 16 logic sectors are reserved for using the system defined by IS09660. In order to secure the compatibility with the existing DVD video standard, the volume/file structure information area having such contents is required.

The DVD video area 13′ has also recorded therein video management information 21 called a video manager (VMG) and at least one type of video contents called the video title sets VTS (VTS #1 to VTS #n) 2 to 24. VMG is the management information for all the VTSs existing in the DVD video area and includes the control data VMGI 31, the video object VMGM_VOBS 32 for VMG menu (option) and the VMGI backup data 33.

This video management information 21 has recorded, in a first play PGCI thereof, for example, a command group constituting the control information for discriminating the type of the optical disk device with the DVD video disk mounted thereon and for defining such a function as the proper jump to the reproduction position. Specifically, FP_PGCI includes a program chain command table (PGC_CMDT), and PGC_CMDT contains the description of a pre-command (PRE_CMD) and a post-command (POST_CMD). These commands allow the process, described later, to reproduce the SD contents and the HD contents accurately without fail.

The command group, which is the control information constituting the features of the present invention, is not necessarily contained in the video management information 21 but may be arranged in any other area, with equal effect, which can be first read by the optical disk device.

Each VTS includes the control data VTSI 41 for the particular VTS, the video object VTSM_VOBS 42 (option) for the VTS menu, the video object VTSTT_VOBS 43 for the title of the contents (movie, etc.) of the particular VTS (title) and the VTSI backup data 44. The DVD video area having these contents is required in order to secure the compatibility with the existing DVD video standard.

In similar fashion, the video title set #2-24 for the HD contents making up the features of the present invention includes the control data #2VTSI 51 for the particular VTS, the video object #2VTSM_VOBS 52 (option) for the VTS menu, the video object #2STT_VOBS 53 for the title of the contents (movie, etc.) of the particular VTS (title) and the VTSI backup data 54.

The reproduction select menu information, etc. for each title (VTS #1 to VTS #n) is supplied in advance by the provider (producer of the DVD video disk) using the VMG. The reproduction chapter select menu and the reproduction process for the recorded contents (cells) in a specific title (for example, VTS #1) are supplied in advance by the provider using VTSI. The disk viewer (user of the DVD player), therefore, can enjoy the contents recorded in the disk d in accordance with the menu of the VMG/VTSI prepared by the provider and the reproduction control information (program chain information PGCI) in the VTSI. An example of the DVD video disk having no features of the present invention is shown in FIG. 2 for reference.

FIG. 3 shows a file structure of the HD-DVD video disk shown in FIG. 1. All the files related to the DVD video area and the HD-DVD video area are classified under a VIDEO_TS holder. Specifically, the files recorded in the VIDEO_TS holder include VIDEO_TS.IFO having recorded therein VMG, VIDEO_TS.VOB having recorded therein the VOB for the VMG menu, VIDEO_TS.BUP having recorded therein the same contents as VIDEO_TS.IFO as a backup, VTS_01_0.IFO having recorded therein VTSI for the SD contents, VTS_01_0.VOB having recorded therein VOB for the VTS menu for the SD contents, VTS_01_1.VOB to VTS_01_2.VOB (assumed to be formed of two files according to this embodiment) having recorded therein VOB of VTS for the SD contents, and VTS_01_0.BUP having recorded therein the same contents as VTS_01_0.IFO as a backup.

Similarly, VTS for HD contents include VTS_02_0.IFO having recorded therein VTSI for HD contents, VTS_02_0.VOB having recorded therein VOB for VTS menu for HD contents, VTS_02_1.VOB to VTS_02_2.VOB (assumed to be formed of two files according to this embodiment) having recorded therein VOB of VTS for HD contents, and VTS_02_0.BUP having recorded therein the same contents as VTS_02_O.IFO as a backup.

(Other Embodiments)

An example in which the DVD video area including SD contents and the HD-DVD video area including HD contents are recorded independently of each other is shown as another embodiment.

FIG. 4 shows another example of the HD-DVD video disk having a dedicated HD-DVD video area 16. This HD-DVD area 16 has recorded therein the video management information 61 for HD contents called the video manager VMG and one or more video contents 62, 63 for HD contents called the video title set VTS (VTS#l to VTS#n).

The VMG 61 is the management information for all the VTSs existing in the HD-DVD video area, and includes the control data VMGI 71 for HD contents, the video object VMGM_VOBS 72 (option) for the VMG menu for HD contents and the VMGI backup data 73.

On the other hand, each VTS 63 includes the control data VTSI 81 for HD contents of the particular VTS, the video object VTSM_VOBS 82 (option) for VTS menu with HD contents, the video object VTSTT_VOBS 83 for the title with the HD contents such as the contents (movie, etc.) of the particular VTS (title) and the backup data 84 of VTSI.

FIG. 5 shows a file structure of the HD-DVD video disk shown in FIG. 4. The files related to the DVD video area are classified under the VIDEO_TS holder. The files related to the HD-DVD video area, on the other hand, are classified under the VIDEO_HD holder. The command group, etc. making up the control information described above, may not only be stored in the video manager information of the VIDEO_TS holder, but also be stored in the video manager information of the VIDEO_HD holder.

The VIDEO_TS holder and the VIDEO_HD holder have recorded thereunder VIDEO_TS.IFO having recorded therein VMG, VIDEO_TS.VOB having recorded therein VOB for VMG menu, VIDEO_TS.BUP having recorded therein the same contents as VIDEO_TS.IFO as a backup, VTS_01_0.IFO having recorded therein VTSI for SD contents, VTS_01_0.VOB having recorded therein VOB for VTS menu, and VTS_01_1.VOB to VTS_01_2.VOB (assumed to be formed of two files according to this embodiment) having recorded therein VOB of VTS, and VTS_01_0.BUP having recorded therein the same contents as VTS_01_0.IFO as a backup.

FIG. 6 shows at least one video object (VOB) 91 stored in the video object areas 32, 42, 43, 52, 53. The video object 91 is configured of one or more video object units (VOBU) 92 constituting the minimum reproduction unit. The video object unit (VOBU) 92 is internally configured of a plurality of main video packs 94 having a control pack 93 at the head thereof, a first voice pack 95 and a second voice pack 95 of which one can be selected, and a first sub-picture pack 96 and a second sub-picture pack 96 of which one is selectable. The selected voice pack 94 and the selected sub-picture pack 96 are reproduced synchronously with the main video pack 94 in the video object unit (VOBU) 92.

As described above, in the DVD video disk according to the present invention, the command information, etc. constituting the control information are also recorded with the SD contents and the HD contents. These command information make it possible to identify the type of the optical disk device, for example, and designate the proper reproduction position and, so that the reproduction process corresponding to the optical disk device can be carried out accurately. As described in detail below, therefore, the reproduction process can be executed accurately regardless of whether an optical disk device is for reproducing only the SD contents or intended also for the HD contents.

(Optical Disk Device According to the Present Invention)

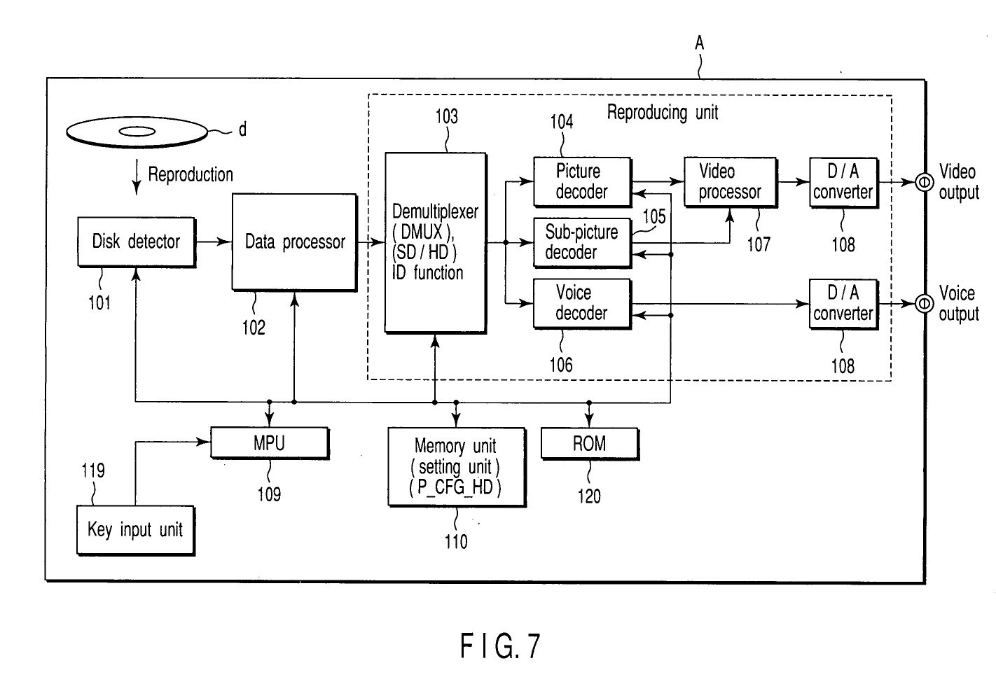

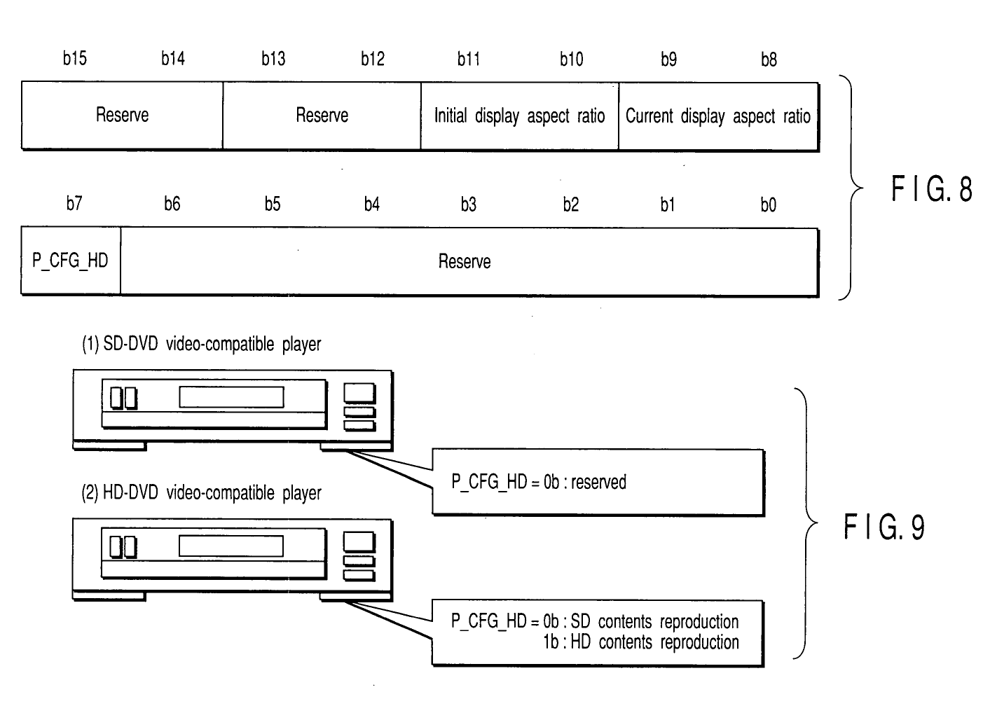

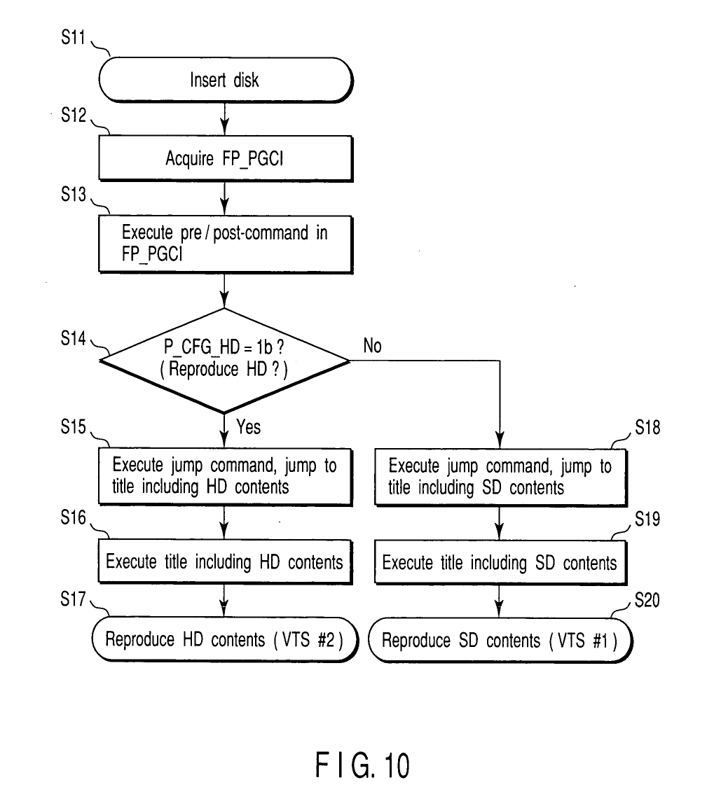

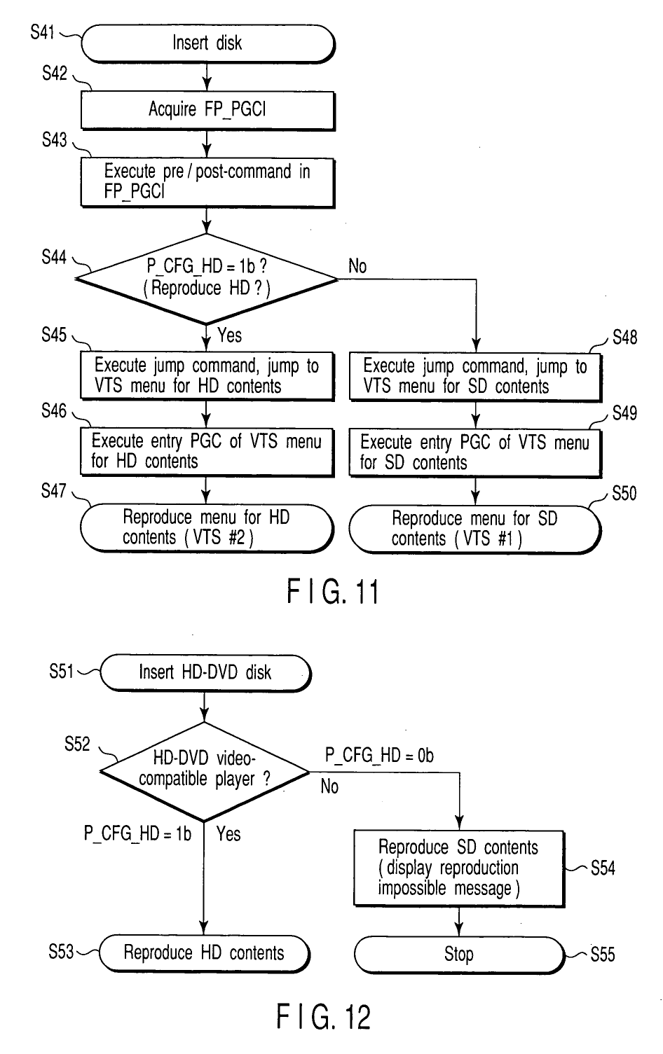

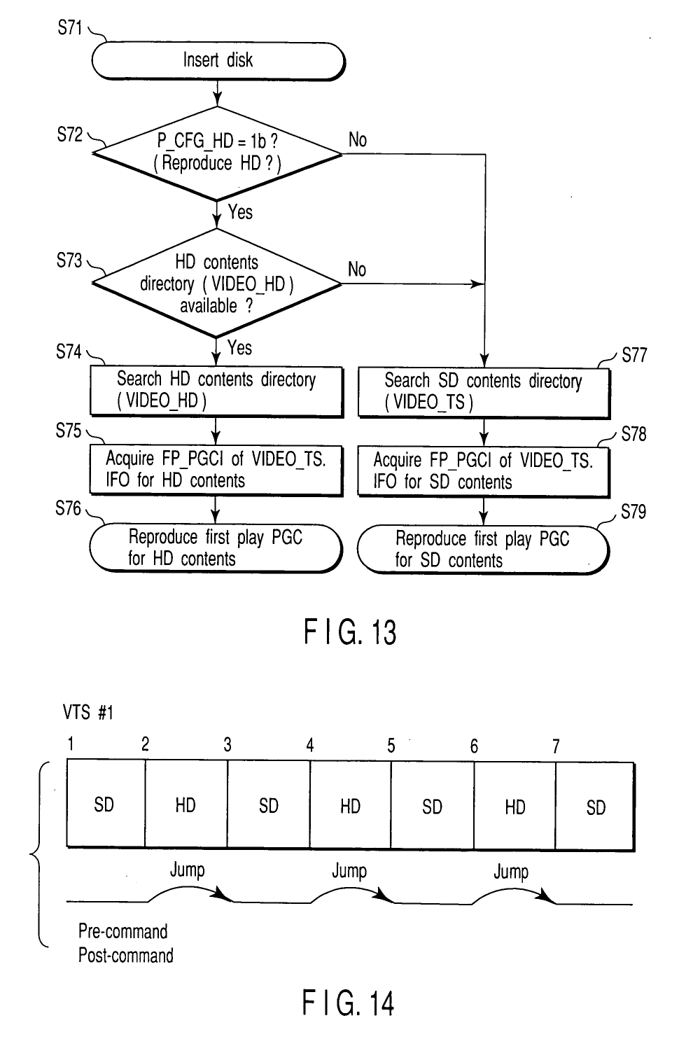

Now, an example of an optical disk device intended for HD contents constituting the features of the present invention will be explained in detail referring to the drawings. FIG. 7 is a block diagram showing an example of a configuration of an optical disk device handling a HD-DVD video disk according to the present invention, FIG. 8 a diagram showing an example of a P_CFG structure for a HD-DVD video disk, FIG. 9 a diagram showing an example of a set value of an optical disk device handling a HD-DVD video disk, FIG. 10 a flowchart showing an example of the process for reproducing the SD/HD contents, FIG. 11 a flowchart showing an example of the process for reproducing the menu of the SD/HD contents, FIG. 12 a flowchart showing an example of an outline of the reproduction process, FIG. 13 a flowchart showing an example of the reproduction process, and FIG. 14 a diagram for explaining a case in which the conventional optical disk device jumps HD in response to a jump command.

The optical disk device according to the present invention is intended for the DVD for recording the HD contents according to the present invention. In this optical-disk device, at least the operation mode for SD contents or HD contents is selectively set and reflected in the system parameter for controlling the player. Further, the SD contents area and the HD contents area in the DVD are identified, and in accordance with the operation mode involved, one of the SD contents and the HD contents is selectively reproduced. The configuration for this operation will be explained below.

In the optical disk device intended for the DVD video disk having recorded therein the HD contents according to the present invention, as shown in FIG. 7, the data are read through a pickup in a disk detector 101 from a DVD video disk d mounted in a tray in the disk detector 101. The data string thus read having the data structure of the DVD video disk d according to the present invention are stored temporarily in a track buffer after the error thereof is corrected in a data processor 102. In accordance with the program stored in the ROM 120 and in compliance with an instruction of which the program is interpreted by an MPU 109, the management information for control data areas 31, 41, 51 stored in the track buffer are stored in a memory 110 and used for reproduction control, data management, etc.

The reproduction data in the video object areas 32, 42, 43, 52, 53 stored in the track buffer, on the other hand, are transferred to a demultiplexer 103. Each pack is sent to a decoder corresponding to the particular pack. Specifically, the main video pack 94 shown in FIG. 6 is sent to a video decoder 104, the voice pack 94 to a voice decoder 106, and the subpicture pack 96 to a sub-picture decoder 105 for the respective decoding process. The demultiplexer 103 has the function of identifying the areas of the SD and HD contents, respectively. Thus, the identification information recorded in, for example, the control data 31, 41, 51 or the video objects 32, 42, 43, 52, 53 of the optical disk device shown in FIG. 1 are read out thereby to identify the areas. In this way, the reproduction process is accurately executed without failing to recognize the areas.

Further, the data processed in the video decoder 104 and the sub-picture decoder 105 are sent to the video processor 107 where the main picture and the sub-picture are superposed one on the other and visually output through a D/A converter 108. The voice data decoded in a voice decoder 106, on the other hand, is aurally output through the D/A converter 108. A key input unit 119 receives an instruction input by the user and transmits it to an MPU 109. The MPU 109 determines the data to be read from the DVD video disk d in accordance with the transmitted instruction, and reproduces the data through the process described above.

(About P_CFG)

The standards of the DVD video disk d include a system parameter (SPRM) for the provider to control the player using a navigation command. The SPRM has a numerical value of two bytes having a fixed length, and each parameter is handled as an unsigned integer of 16 bits with SPRM (SPRM (0) to SPRM (23)) of 24 players. Among them, SPRM (11) to SPRM(20) are called the player parameters which are values set for the players. Especially, SPRM (14) is called the video player structure (P_CFG), and as shown in FIG. 8, configured of the initial display aspect ratio indicating the display aspect ratio selected by the user and the current display mode indicating the current video output mode of the player in the current domain.

Further, the HD-DVD video disk has the P_CFG_HD, as an extension of the conventional P_CFG, designating the display mode of the player, as shown in FIG. 8. This parameter, which is defined as the reproduction of the SD contents in the case where P_CFG_HD is “0b” and as the reproduction of the HD contents when it is “1b”, is used for discrimination of the SD and HD contents for reproduction. They can be stored, for example, in the memory 110 shown in FIG. 7.

FIG. 9 shows the values of P_CFG_HD for (1) the SD-DVD video-compatible player, and (2) the HD-DVD video-compatible player. The SD-DVD video-compatible player in (1) is based on the DVD video standard, and this value is set to 0b as a reserved area. The HD-DVD video-compatible player (2), in contrast, has the function of switching the reproduction mode between SD contents and HD contents, and in the case where the value thereof is set to 0b, the SD contents of the DVD video disk or the HD-DVD disk are reproduced. In the case where the value is set to 1b, on the other hand, the HD contents of the HD-DVD video disk are reproduced. As a method of switching this value, the value can be selected by the user according to the function setting menu of the player or can be set automatically by the player.

Specifically, the user desirous of reproducing the HD contents in priority can set the structure (P_CFG_HD) for the video player to “b” by setting the operation mode to the reproduction of the HD contents according the function setting menu through the key input unit 119.

(Reproduction Processing Operation)

FIG. 10 is a flowchart showing a case in which the title of the SD contents or the HD contents is reproduced when the HD-DVD disk with the SD contents and the HD contents shown in FIG. 1 recorded therein is inserted into the DVD player.

In the flowchart of FIG. 10, the insertion of the disk (S11) permits the DVD player to acquire the first plate PGCI (FP_PGCI) constituting a part of the video management information 21 (S21). FP_PGCI contains a program chain command table (PGC_CMDT), which in turn contains the description of the pre-command (PRE_CMD) and the post-command (POST_CMD).

As this pre-command and the post-command, for example, the P_CFG_HD constituting a part of the configuration information of the player is accessed and the comparison command is executed (S13). In the case where PC_CFG_HD is 0b (S14), the jump command (JumpTT) is executed and the process is jumped to the title associated with VTS #1 including the SD contents (S15). In the case where PC_CFG_HF is 1b (S14), on the other hand, the jump command (JumpTT) is executed and the process is jumped to the title associated with VTS #2 including the HD contents (S18). The command group described above is described in FP_PGCI.

In the case where this HD-DVD video disk is inserted into the DVD player intended only for the reproduction of SD contents, the value of PC_CFG_HD constituting a part of the player configuration information is set to 0b indicating the reserved area. Therefore, the DVD player executes the jump command (JumpTT) in accordance with the description of FP_PGCI and reproduces the title of VTS #1 including the SD contents (S19, S20).

In the case where this HD-DVD video disk is inserted into the HD-DVD video-compatible player, on the other hand, the value of PC_CFG_HD constituting a part of the player configuration information is set to either 0b for reproducing the SD contents or 1b for reproducing the HD contents. In the case where the value PC_CFG_HD is set to 0b (S14), the jump command (JumpTT) is executed and the title of VTS #1 including the SD contents is reproduced (S19, S20). In the case where PC_CFG_HF is 1b (S14), the jump command (JumpTT) is executed, and the title of VTS #2 including the HD contents is reproduced (S16, S17). At the same time, the SD/HD contents are accurately reproduced by the use of the result of area identification by the SD/HD identification function of the demultiplexer 103.

As described above, the identification command and the command for executing the title of the HD contents and the SD contents are recorded in the first play PGCI (FP_PGCI) of the video management information 21, for example, of the HD-DVD video disk shown in FIG. 1. In this way, the reproduction process can be executed smoothly for both the optical disk device intended only for the SD contents and the optical disk device intended for the HD contents.

Further, the execution of the VTS menu of the SD contents or the HD contents will be explained referring to the flowchart of FIG. 11. FIG. 11 is a flowchart showing the operation of reproducing the menu of the SD contents or the HD contents when the HD-DVD video disk having recorded therein the SD contents or the HD contents shown in FIG. 1 is inserted into the DVD player.

In the flowchart of FIG. 11, when the disk is inserted (S41), the DVD player acquires the first play PGCI (FP_PGCI) constituting a part of the video management information 21 (S42). The FP_PGCI contains the program command table (PGC_CMDT), which in turn contains the description of the pre-command (PRE_CMD) and the post-command (POST_CMD).

As this pre-command or post-command, for example, the P_CFG_HD constituting a part of the player configuration information is accessed and the comparison command is executed (S43). In the case where PC_CFG_HD is 0b (S44), the jump command (JumpSS) is executed (S45) and the execution of the entry PGC of the menu for the SD contents associated with VTS #1 is started (S46). In the case where PC_CFG_HF=1b (S44), on the other hand, the jump command (JumpSS) is executed (S45), and the execution of the entry PGC of the menu for the HD contents associated with VTS #2 is started (S46), whereby the menu for the HD contents is reproduced (S47). The aforementioned command group is described in FP_PGCI.

In the case where this HD-DVD video disk is inserted into the DVD player intended only for the SD contents (S41), the value of PC_CFG_HD constituting a part of the player configuration information is set to 0b indicating a reserved area. The DVD player, therefore, executes the jump command (JumpSS) in accordance with the description of FP_PGCI (S48), executes the entry PGC of the menu for the SD contents associated with VTS #1 (S49), and reproduces the video object for the menu of the SD contents (S50). At the same time, the SD contents are reproduced accurately using the result of area identification by the SD/HD identification function of the demultiplexer 103.

In the case where this HD-DVD video disk is inserted into the HD-DVD video-compatible player, the value of PC_CFG_HD constituting a part of the player configuration information is set to either 0b for reproducing the SD contents or to 1b for reproducing the HD contents. In the case where the PC_CFG_HD value is set to 0b (S44), the jump command (JumpSS) is executed (S48) and the entry PGC of the menu for the SD contents associated with VTS #1 is executed (S49), and the video object for the menu of the SD contents is reproduced (S50). In the case where PC_CFG_HF is 1b (S44), on the other hand, the jump command (JumpSS) is executed (S45), the entry PGC of the menu for the HD contents associated with VTS #2 is executed (S46), and the video object for the menu of the HD contents is reproduced (S47). At the same time, the HD contents are accurately reproduced by the use of the result of area identification by the SD/HD identification function of the demultiplexer 103.

As described above, in the optical disk device intended for the HD contents, the player configuration information (P_CFG_HD) provided therein is extended. In the HD-DVD video disk, therefore, the reproduction process can be smoothly executed for both the optical disk device intended only for the SD contents and the optical disk device intended for the HD contents by recording the aforementioned command group, for example, in the first play PGCI (FP_PGCI) of the video management information 21.

(Display of Reproduction Impossible Message)

Further, as shown in the flowchart of FIG. 12, in a HD-DVD video disk constituted only by the HD contents, a rejection message described below can be displayed for an optical disk device capable of reproducing only the SD contents. Specifically, when fabricating the HD-DVD video disk constituted only by the HD contents, a rejection message such as “This disk can perform no reproducing operation on this DVD player” or the like is prepared in SD contents and recorded in the HD-DVD video disk together with the HD contents described above.

In the flowchart of FIG. 12, therefore, when the HD-DVD disk is inserted (S51) to perform the reproducing operation with the conventional player intended only for the SD contents (S52), the fact that this disk is incompatible with the player is displayed as a message (S54) thereby to stop the operation suitably (S55). In the case where the HD-DVD disk is used with a HD-DVD video-compatible player for reproduction (S52), on the other hand, the HD contents are reproduced (S53).

As a result, the user is not confused as to whether the optical disk device is in malfunction or not in the case where the HD-DVD video disk mounted on an optical disk device dedicated to the SD contents is unable to perform the reproducing operation.

(Reproduction by Holder-separated DVD)

Next, the reproducing process by a DVD with the SD contents and the HD contents shown in FIG. 5 recorded in different holders will be described referring to the flowchart of FIG. 13. In FIG. 13, an example of an operation for reproducing the first play PGC of the SD contents or the HD contents is shown in a flowchart referring to a case in which a HD-DVD video disk having recorded therein the SD contents and the HD contents shown in FIG. 4 is inserted into the DVD player.

In the flowchart of FIG. 13, the disk is inserted (S71). In the case of the conventional DVD player intended only for the SD contents (S72), the value of PC_CFG_HD constituting a part of the player configuration information is set to 0b indicating a reserved area. The DVD player, therefore, reads the VIDEO_TS.IFO under the directory having recorded therein the SD contents (VIDEO_TS) (S77) and in accordance with the first play PGCI in the management information thereof (S78), the SD contents are reproduced (S79).

In the case of a HD-DVD video-compatible player, on the other hand, the value of PC_CFG_HD constituting a part of the player configuration information is set to either 0b for reproducing the SD contents or 1b for reproducing the HD contents. In the case where the PC_CFG_HC is set to 0b (S72), the player reads the VIDEO_TS.IFO under the directory (VIDEO_TS) having recorded therein the SD contents, and reproduces the SD contents in accordance with the first play PGCI in the management information thereof.

In the case where the PC_CFG_HD is set to 1b (S72), on the other hand, the player searches the disk for the directory (VIDEO_HD) having a file with the HD contents recorded therein (S73). In the absence of a directory (VIDEO_HD) having a file with the HD contents recorded therein (S73), it indicates that the particular disk is a DVD video disk having recorded therein only the SD contents. Therefore, the player reads the VIDEO_TS.IFO under the directory (VIDEO_TS) with the SD contents recorded therein (S77), and in accordance with the first play PGCI in the management information thereof (S78), reproduces the SD contents (S79).

In the presence of a directory (VIDEO_HD) having a file with the HD contents recorded therein (S73), on the other hand, this disk is a HD-DVD video disk. Therefore, the player reads the VIDEO_TS.IFO under the directory (VIDEO_HD) with the HD contents recorded therein (S74), and in accordance with the first play PGCI in the management information thereof (S75), reproduces the HD contents (S76).

As described above, in the case where the DVD video disk according to the present invention takes such a form that the SD contents and the HD contents are stored in different holders as shown in FIG. 5, each holder is accessed following the steps described above for reproduction.

(Avoidance of HD Contents by Jump)

Further, in addition to the command for interpreting the player configuration information, a jump command for jumping the HD contents is recorded as shown in FIG. 14 in the areas of the control data 31, 41, 51 of the DVD video disk according to the present invention. In this way, the HD contents are not erroneously reproduced in the optical disk device intended only for the SD contents or in the optical disk device set to the operation mode for reproducing only the SD contents but capable of handling also the HD contents.

Furthermore, in addition to the jump of the HD contents, a jump command for jumping the SD contents can be suitably recorded, together with the command for interpreting the player configuration information, etc., in the areas of the control data 31, 41, 51 of the DVD video disk according to the present invention. As a result, the inconvenience of causing the malfunction of erroneously reproducing the SD contents can be eliminated by jumping and avoiding the SD contents in an optical disk device which is intended for reproducing only the HD contents or which is set to the operation mode for reproducing only the HD contents. Thus, an optical disk device having a superior operation stability can be provided.

An optical disk such as a DVD video disk and an optical disk device according to the present invention are described above. With regard to an optical disk having both the SD contents and HD contents, assume that the SD contents or the HD contents are read by the optical disk device dedicated to the SD contents in compliance with a command or the like recorded in the control information. The type of the optical disk device is detected, and in response to this, the process is jumped to a corresponding SD menu or title or an appropriate message is displayed. In this way, the process is properly executed without causing a malfunction. Further, also in an optical disk device intended for the HD contents, the process is transferred to the menu or title of the SD contents or the HD contents in accordance with a set operation mode, thereby making possible appropriate reproduction processing.

Based on the various embodiments described above, the present invention can be implemented by those skilled in the art. Also, it is easy for those skilled in the art to conceive various modifications of these embodiments and thus to apply the present invention to various embodiments without any inventive ability. Therefore, the present invention covers a wide scope without departing from the principle and the new features disclosed herein and not limited to the embodiments described above.

It will thus be understood from the foregoing detailed description that according to the present invention, there is provided an optical disk such as a DVD having recorded therein both SD contents and HD contents, which achieves the reproducing process properly for both an optical disk device capable of reproducing only the SD contents and an optical disk device capable of reproducing both the SD contents and the HD contents, based on the control information such as a command recorded in a predetermined area.

What is claimed is:

1. An optical disk, wherein two types of video objects including first contents and second contents are recorded, the optical disk further having recorded therein predetermined control information.

2. An optical disk according to claim 1, wherein the predetermined control information is to determine the type of the optical disk device on which the disk is mounted.

3. An optical disk according to claim 2, wherein the control information to reproduce at least one of the titles of the first contents and the second contents is further recorded based on the type of the optical disk device determined with the optical disk mounted thereon.

4. An optical disk according to claim 2, wherein the menu information of the first contents and the menu information of the second contents are recorded, the optical disk further having recorded therein the control information to reproduce at least one of the menu information of the first contents and the menu information of the second contents based on the type of the optical disk device determined with the optical disk mounted thereon.

5. An optical disk according to claim 2, wherein the control information to avoid the reproduction of the first contents is further recorded based on the type of the optical disk device determined with the optical disk mounted thereon.

6. An optical disk according to claim 1, wherein the holder to store the video object of the second contents and the holder to store the video object of the first contents are identical with each other.

7. An optical disk according to claim 1, wherein the holder to store the video object of the second contents and the holder to store the video object of the first contents are different from each other.

8. An optical disk device comprising:
a detecting unit to rotate an optical disk at a predetermined speed thereby to detect the first contents, the second contents and the control information, the optical disk having recorded therein video objects of two types of contents including the first contents and the second contents and further having recorded therein predetermined control information;
a setting unit to set the set information to reproduce one of the first contents and the second contents; and
a reproducing unit to reproduce at least one of the first contents and the second contents based on the control information detected by the detecting unit and the set information set by the setting unit.

9. An optical disk device according to claim 8, wherein the setting unit sets the setting information, and in accordance with the set information, rewrites the value of the video player configuration of a system parameter.

10. An optical disk device according to claim 8, wherein the reproducing unit reproduces at least one of the title of the first contents and the title of the second contents based on the control information detected by the detecting unit and the set information set by the setting unit.

11. An optical disk device according to claim 8, wherein the reproducing unit reproduces at least one of the menu of the first contents and the menu of the second contents based on the control information detected by the detecting unit and the set information set by the setting unit.

12. An optical disk device according to claim 8, wherein the reproducing unit accesses the holder having stored therein the second contents when reproducing the second contents and accesses the holder having stored therein the first contents different from the holder having stored therein the second contents when reproducing the first contents separately.
